(19) United States
(12) Patent Application Publication
(10) Pub. No.: US 2007/0094678 A1
(43) Pub. Date: Apr. 26, 2007

(54) Detachable structure for disk drive

(75) Inventor: Yin-Kang Tu, Taoyuan Hsien (TW)

Correspondence Address: TROXELL LAW OFFICE PLLC, Suite 1404, 5205 Leesburg Pike, Falls Church, VA, 22041, US

(73) Assignee: Enlight Corporation

(21) Appl. No.: 11/258,231

(22) Filed: Oct. 26, 2005

(51) Int. Cl. G11B 33/02

(52) U.S. Cl. 720/657

(57) ABSTRACT

A detachable structure is designed for detachably mounting a disk drive on a mounting frame. A clasping means is mounted on one side of the disk drive for positioning the disk drive on the mounting frame. For the purpose of detaching the disk drive, the elastic protruding part of the clasping means is pushed inwardly by pushing the push-pull control means such that the push-resisting part of the push-pull control means can push out the disk drive directly.

### FIELD OF THE INVENTION

The present invention relates to a detachable structure for a disk drive, and more particularly to a detachable structure that enables the disk drive to be attached or detached easily by a simple operation.

### BACKGROUND OF THE INVENTION

The general hard disk drive, soft disk drive, and CD-ROM drive are usually fixedly mounted on the inside of a machine case of a computer host by simple mounting frames. Traditionally, the disk drives are fixedly secured to the mounting frames by several fixing devices after the disk drives have been located on the mounting frames. As a result, if there is a need to attach or detach the disk drives, the applying of auxiliary tools for fastening or loosening the fixing devices is unavoidable and requires much time and work.

### SUMMARY OF THE INVENTION

In view of the above-mentioned problems, the present inventor discloses an improved detachable structure for a disk drive in accordance with many years experience in this art.

In accordance with one aspect of the present invention, a detachable structure is designed for detachably mounting a disk drive on a mounting frame. A clasping means is mounted on one side of the disk drive for positioning the disk drive on the mounting frame. For the purpose of detaching the disk drive, the elastic protruding part of the clasping means is pushed inwardly by pushing the push-pull control means such that the push-resisting part of the push-pull control means can push out the disk drive directly.

Other objects and features of the present invention will become apparent from the following detailed description when taken in conjunction with the drawings in which:

### BRIEF DESCRIPTION OF THE DRAWINGS

These and other features, aspects and advantages of the present invention will become better understood with regard to the following description, appended claims, and accompanying drawings, where:

FIG. 1 is an elevational view showing the structure of the present invention;

FIG. 2 is an elevational view showing that the structure of the present invention is applied to the inside of a host;

FIG. 3 is an exploded elevational view showing the disk drive and the clasping means of the present invention;

FIG. 4 is a schematic top view showing the disk drive in an attached state;

FIG. 5 is a partial enlarged schematic view showing the section encircled in FIG. 4; and

FIG. 6 is a schematic top view showing the disk drive in a detached state.

### DETAILED DESCRIPTION OF THE PREFERRED EMBODIMENT

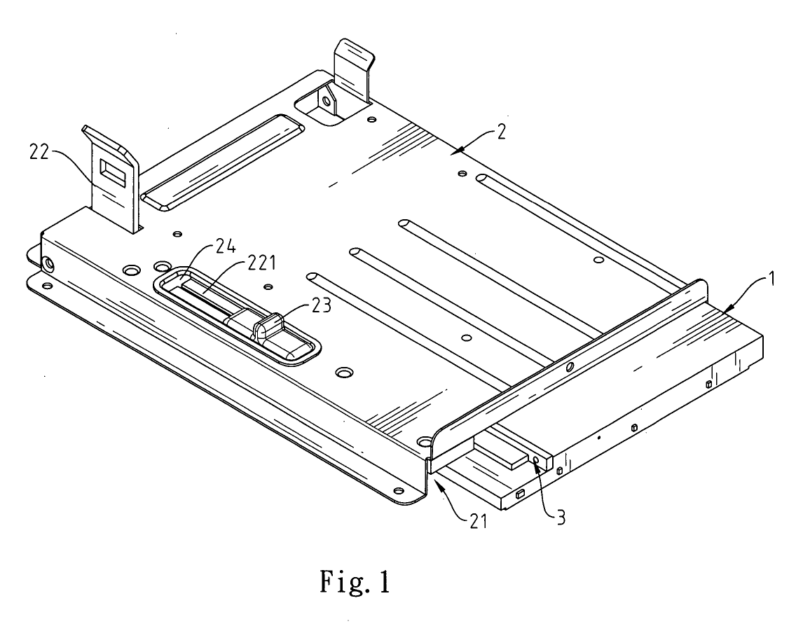

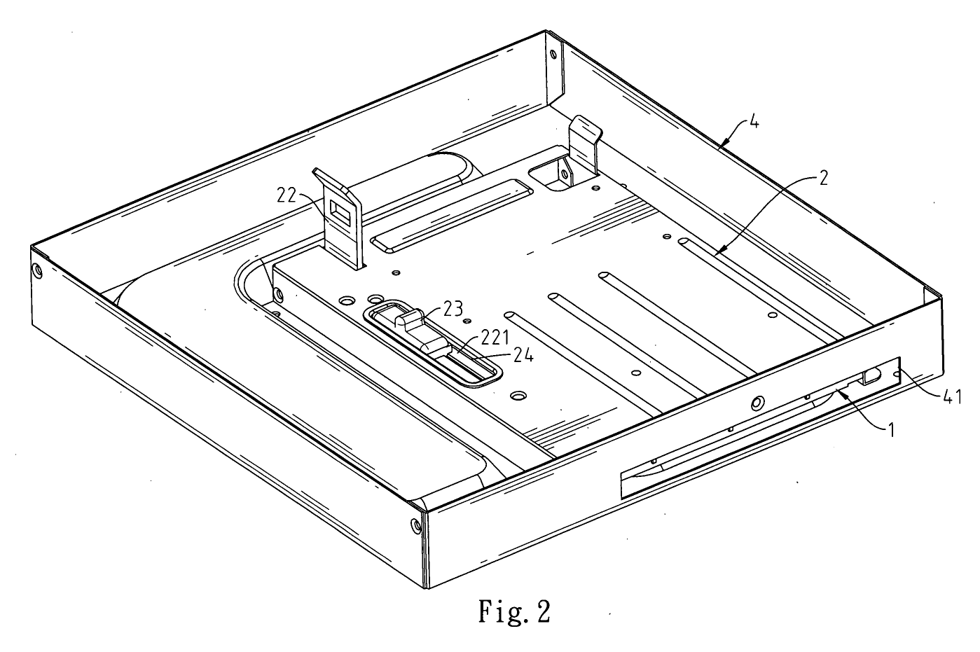

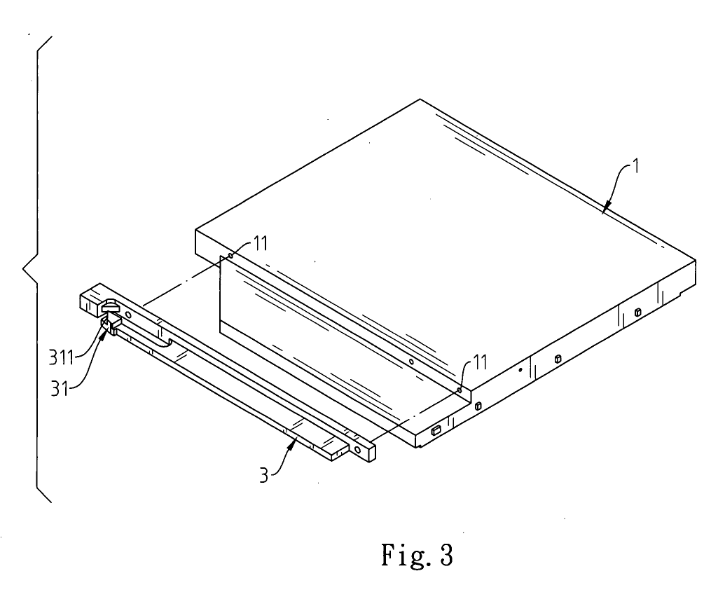

Referring to FIG. 1, FIG. 2 and FIG. 3, a detachable structure for a disk drive of the present invention is to detachably couple the disk drive to the inside of a mounting frame 2. The mounting frame 2 is fixedly mounted on the inside of a machine case 4. The disk drive 1 can be located under the mounting frame 2 in a location corresponding to an opening trench 41 of the machine case 4 to facilitate the detachment of the disk drive 1.

The above-mentioned mounting frame 2 has a lower mounting space 21 for receiving the disk drive 1. A lateral rail 22 is mounted in the lower mounting space 21 on one side of the mounting frame 2. The lateral rail 22 has a slideway 221 for receiving a push-pull control means 23. The slideway 221 is mounted in an operation trench 24 by use of its upper action part such that the slideway 221 is slidable along the lateral rail 22 within the scope of the operation trench 24. A push-resisting part 231 and a convex top block 232 are mounted on one side of the push-pull control means 23. The push-resisting part 231 and the convex top block 232 jointly constitute a L-shaped structure for pushing the disk drive 1.

A clasping means 3 is mounted on one side of the disk drive 1 that mounts in the lower mounting space 21 of the mounting frame 2 for facilitating the detachment of the disk drive 1. An elastic protruding part 31 is mounted on one outer end of the clasping means 3. The elastic protruding part 31 has a sloping edge 311. The elastic protruding part 31 is located corresponding to the convex top block 232 of the push-pull control means 23 such that they are interactive.

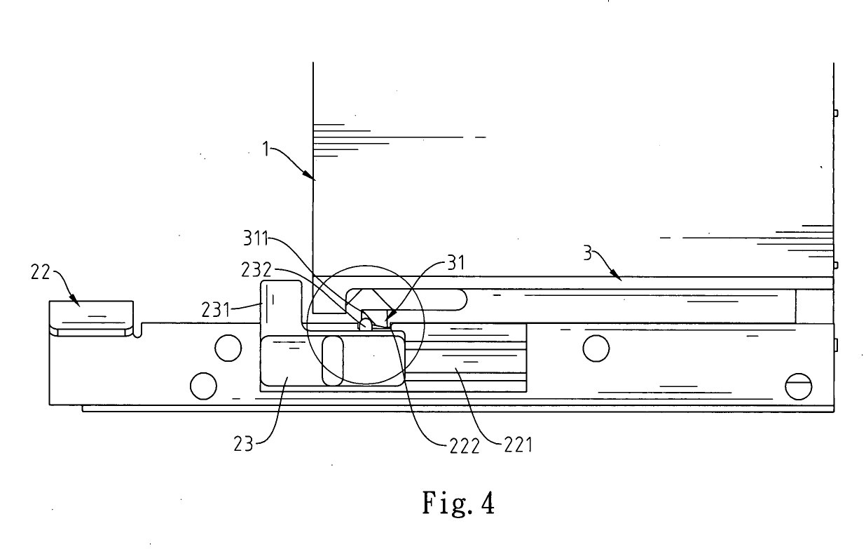

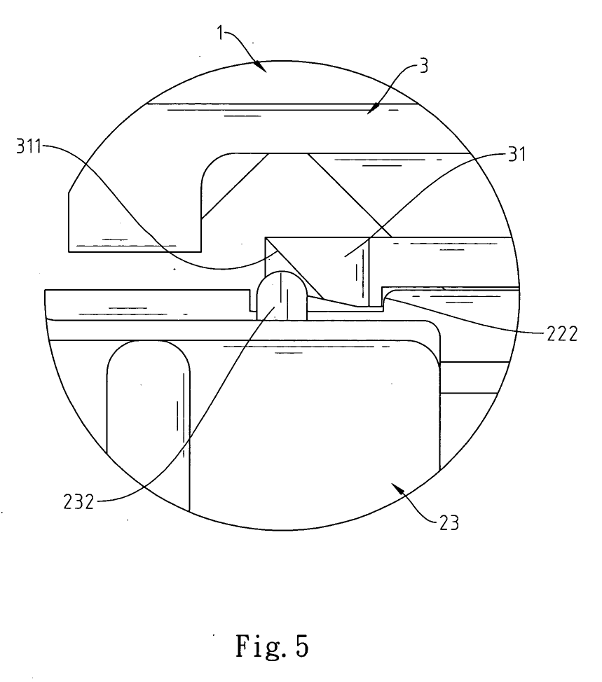

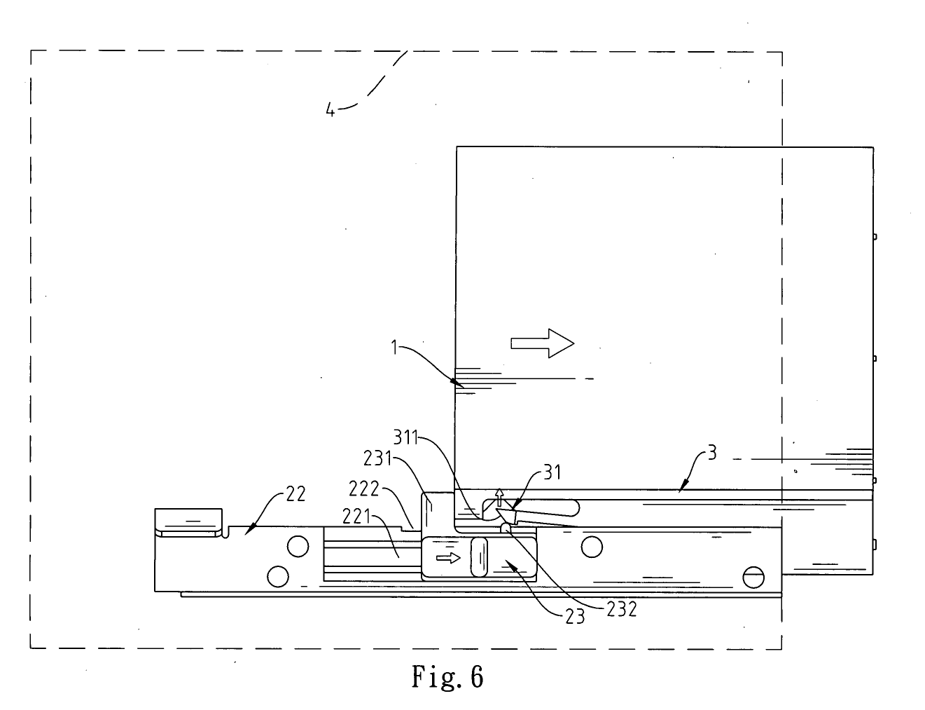

Referring to FIG. 4 through FIG. 6, these figures are schematic views showing the attachment and detachment of the disk drive 1. When the disk drive 1 that has the clasping means 3 mounted on one side thereof is inserted into and coupled to the lower mounting space 21 of the mounting frame 2, the elastic protruding part 31 of the clasping means 3 can be positioned by hooking a notch 222 of the slideway 221 such that the push-pull control means 23 is located upper than the elastic protruding part 31 and that the convex top block 232 is located above the elastic protruding part 31. Besides, at this moment, the push-resisting part 231 is located away from the edge of the disk drive 1.

Accordingly, if there exists a desire to detach the disk drive 1, the only thing that needs to be done is to push the push-pull control means 23 such that the convex top block 232 of the push-pull control means 23 leans against the sloping edge 311 of the elastic protruding part 31 to push the elastic protruding part 31 inwardly. At this moment, the push-resisting part 231 of the push-pull control means 23 also leans against and, thereafter, pushes out the disk drive 1 such that the disk drive 1 is at a distance extending from the machine case 4 for being taken out.

What the invention claimed is:

1. A detachable structure for a disk drive, comprising:
a mounting frame attached to the inside of a machine case, the mounting frame having a lower mounting space for receiving the disk drive;
a lateral rail mounted in the lower mounting space on one side of the mounting frame;
a slideway slidably mounted in an operation trench of the lateral rail by use of an upper action part thereof for receiving a push-pull control means;
a push-resisting part and a convex top block mounted on one side of the push-pull control means for pushing the disk drive;
a clasping means mounted on one side of the disk drive; and
an elastic protruding part having a sloping edge formed on an outer end of the clasping means corresponding to the convex top block of the push-pull control means.
